(19) United States
(12) Patent Application Publication
(10) Pub. No.: US 2023/0012196 A1
(43) Pub. Date: Jan. 12, 2023

(54) OPERATING EMBEDDED TRAFFIC LIGHT SYSTEM FOR AUTONOMOUS VEHICLES

(71) Applicant: HERE Global B.V., Eindhoven (NL)

(72) Inventors: Lidia Alejandra Abundis Vargas, Lomas de la Trinidad (MX); Luis Armando Amador Duran, San Isidro (MX); Aidee Montserrat Pérez Reyes, Los Cárcamos (MX); Ignacio Alejandro Rodríguez Becerra, Brisas del Pedregal (MX)

(21) Appl. No.: 17/370,797

(22) Filed: Jul. 8, 2021

(51) Int. Cl. G08G 1/0968; G08G 1/01; G06N 20/00; H04W 4/40

(52) U.S. Cl. CPC G08G 1/096844; G08G 1/0129; G08G 1/0145; G06N 20/00; H04W 4/40

(57) ABSTRACT

A method of directing traffic flow includes receiving, by a processor, navigation information from a vehicle in a multi-edge communication network, and receiving, by the processor, a status of an edge node traffic control device of the multi-edge communication network. The edge node traffic control device is configured to regulate traffic flow on a path segment. The method includes determining, by the processor, a navigation command based on the navigation information and the status, and outputting, by the processor, the navigation command to the vehicle through the multi-edge communication network.

### FIELD

The following disclosure relates to operation of a traffic light system.

### BACKGROUND

Road traffic is regulated by traffic lights. Current infrastructure in cities still relies on physical traffic lights. Traffic flow may be negatively impacted if the traffic light malfunctions. Such malfunctions may occur based on the infrastructure relied upon by the traffic lights, such as the power transmitted to the traffic light over wires. Even under normal operating conditions, physical traffic lights may inefficiently direct traffic, resulting in additional driving time, increased traffic, and unnecessary emissions.

The physical traffic light presents other problems when combined with human vehicle operators. For example, while driving a vehicle and reaching a Traffic Light, a larger vehicle in front of the vehicle may obscure the traffic light, resulting in slowed traffic flow and increasing the likelihood of an accident.

Physical traffic lights may communicate in certain vehicles equipped with sensors. Coordination between the physical traffic light and the vehicles may allow for the timing of the traffic light to be adapted. However, such approaches rely on the location of the traffic light present at the intersection to create a local area for communication between the physical traffic light and vehicles.

### SUMMARY

In one embodiment, a method of directing traffic flow includes receiving, by a processor, navigation information from a vehicle in a multi-edge communication network, and receiving, by the processor, a status of an edge node traffic control device of the multi-edge communication network. The edge node traffic control device is configured to regulate traffic flow on a path segment. The method includes determining, by the processor, a navigation command based on the navigation information and the status, and outputting, by the processor, the navigation command to the vehicle through the multi-edge communication network.

In one embodiment, a traffic control system includes a multi-edge network including a memory, and a processor in communication with the memory and configured to execute instructions stored in the memory operable to receive navigation data from a vehicle in communication with the multi-edge network, and receive a status of an edge node traffic control device of the traffic control system and in communication with the multi-edge network. The edge node traffic control device is configured to regulate traffic flow on a path segment. The instructions are operable to determine a navigation command based on the navigation data and the status, and output the navigation command to the vehicle through the multi-edge network.

In one embodiment, a non-transitory computer-readable medium includes instructions that when executed are operable to: receive navigation data from a vehicle via a vehicle-to-node link of a communication network, and receive a status of an edge node traffic control device in communication with the communication network. The edge node traffic control device is configured to regulate traffic flow on a path segment. The instructions are operable to determine a navigation command based on the navigation data and the status, and output the navigation command to the vehicle through the vehicle-to-node link of the communication network.

### BRIEF DESCRIPTIONS OF THE DRAWINGS

Exemplary embodiments of the present invention are described herein with reference to the following drawings.

FIG. 1 illustrates a first embodiment of a traffic light system.

FIG. 2 illustrates a first embodiment of vehicle communication.

FIG. 3 illustrates a second embodiment of vehicle communication.

FIG. 4 illustrates a second embodiment of a traffic light system.

FIG. 5 illustrates an example flow chart for the systems of FIG. 1 and FIG. 4.

FIG. 6 illustrates an example server for the system of FIG. 1.

FIG. 7 illustrates an example traffic control device for the systems of FIG. 1 and FIG. 4.

FIG. 8 illustrates an exemplary vehicle associated with the systems of FIG. 1 and FIG. 4.

FIG. 9 illustrates an exemplary database.

### DETAILED DESCRIPTION

Given the problems with physical traffic lights and the increasing prevalence of autonomous vehicles (AVs), traffic flow may be better regulated in an “AV ready” traffic light system (TLS). Current traffic light systems may be monitored and controlled through remote programming of the lights or a human operator introducing human error into the system. Because AVs may be controlled considering acceleration and deceleration of vehicles and how to control them, driver dependency on physical traffic lights may be made obsolete. The physical traffic light structure may be replaced by a system using communication from vehicle sensors, inter-vehicle communication, and platooning to improve traffic flow, diminish lost time while driving, make traffic flow ratios more efficient, and remove human error.

Communications in the AV ready TLS may flow according to a multi-edge access computing (MEAC) design. MEAC is a communication network that use edges of a network, such as AVs, mobile devices, and network nodes, to perform computing tasks, instead of relying on a centralized cloud. By relying on the edges of the network for processing, latency may be reduced and real-time performance may be realized. Because traffic flow regulation requires many simultaneous, coordinated, and real-time tasks, MEAC is particularly adapted to implement an AV ready TLS capable of replacing a physical traffic light system. Further, because the AV ready TLS includes computer vision (e.g. from sensors onboard vehicles), the TLS may exist as a layer in a MEAC network, enabling updates as road and wireless communication infrastructure changes and AV capabilities improve. Overall, the AV ready TLS creates a more efficient and robust traffic regulation system that existing approaches that rely on physical infrastructure present at an intersection.

In some cases, the Av ready TLS may implement one or more machine learning (ML) frameworks to regulate traffic. The ML framework may receive one or more variables, such as historic data of number of vehicles transiting an intersection, historic data of accidents reported at an intersection, and reality index data (e.g. including vehicle speed and information on traffic patterns). With the input data the ML framework may provide recommendations to change elements of the AV ready TLS, such as the timing of traffic stops at intersections. In this way, the ML framework and the AV ready TLS enable better urban planning for AVs and more efficient applications of vehicle communications in the MEAC network.

Moreover, because the AV retains a consistent connection to the TLS, improvements in the function of the AV may be realized. For example, the connection to the TLS may help AVs enable driver assistance features, meet security regulations, avoid proximity accidents, and report telemetric data in the event of an accident. In the case of a car crash or AV malfunction, the information transmitted from the AV to the TLS may be analyzed through in conjunction with information regarding traffic signal timing, speed, acceleration, deceleration, and the moment of the impact.

AVs are vehicles including one or more driver assistance features. The driver assistance features aid drivers in driving and parking a vehicle. Such features may sometimes be referred to as “automated driving,” “highly assisted driving,” “advanced driving assistance systems,” or “autonomous driving,” but driver assistance features may have different levels of sophistication, ranging from simple warning to complex systems that may drive a car without user input. The driver assistance features may be enabled by an engine control management (ECM) system on a vehicle. The driver assistance features may rely on different sensor technologies and high definition (HD) MAP or dynamic backend content, including traffic information services, to aid the in-vehicle ECM system for the right decision strategy as how to drive along the road network.

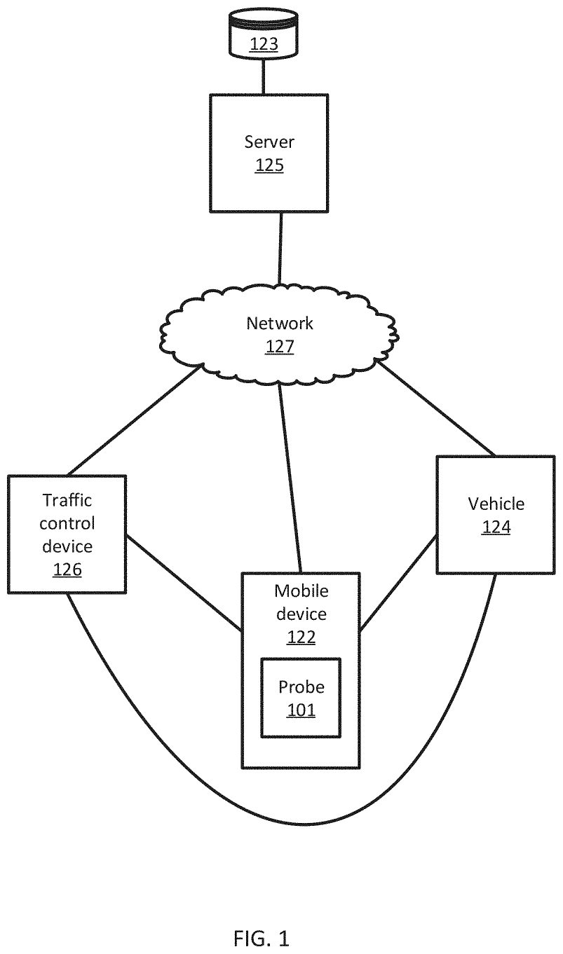

FIG. 1 illustrates a first embodiment of a traffic light system including a mobile device 122, a vehicle 124, a server 125, a traffic control device 126, and a network 127. The vehicles 124 may be directly connected to the server 125 or through an associated mobile device 122 or another intermediary. Additional, different, or fewer components may be included in the system. The following embodiments may be entirely or substantially performed at the server 125, at the traffic control device 126, at the vehicle 124, or at the mobile device 122. In some examples, some aspects are performed at the mobile device 122, other aspects are performed at the traffic control device 126, other aspects are performed at the vehicle 124, and still some other aspects are performed at the server 125.

The mobile device 122 may include a probe 101 or position circuitry such as one or more processors or circuits for generating probe data. The probe points are based on sequences of sensor measurements of the probe devices collected in the geographic region. The probe data may be generated by receiving GNSS signals and comparing the GNSS signals to a clock to determine the absolute or relative position of the mobile device 122. The probe data may be generated by receiving radio signals or wireless signals (e.g., cellular signals, the family of protocols known as WIFI or IEEE 802.11, the family of protocols known as Bluetooth, or another protocol) and comparing the signals to a pre-stored pattern of signals (e.g., radio map). The mobile device 122 may act as the probe 101 for determining the position or the mobile device 122 and the probe 101 may be separate devices.

The probe data may include a geographic location such as a longitude value and a latitude value. In addition, the probe data may include a height or altitude. The probe data may be collected over time and include timestamps. In some examples, the probe data is collected at a predetermined time interval (e.g., every second, every 100 milliseconds, or another interval). In this case, there are additional fields like speed and heading based on the movement (i.e., the probe reports location information when the probe 101 moves a threshold distance). The predetermined time interval for generating the probe data may be specified by an application or by the user. The interval for providing the probe data from the mobile device 122 to the server 125 may be the same or different than the interval for collecting the probe data. The interval may be specified by an application or by the user. In some other cases, the probe data is collected dynamically or at different rates. For example, the rate at which the probe data is received may vary based on a trajectory or dynamic behavior of a vehicle or mobile device 122 (e.g. whether the mobile device 122 is travelling at one speed or accelerating/decelerating), a complexity of a path travelled by the mobile device 122 currently or in the future (e.g. whether the mobile device 122 is approaching an intersection, offramp, roundabout), or traffic conditions (e.g. accumulation or dissipation of traffic congestion).

The database 123 may be a geographic database. The geographic database 123 may store information including maps and location data generated by the probes 101. In some cases, the geographic database may store historical traffic data. The geographic database 123 may be configured to send information, such as historical traffic data, to the server 125. Information stored in the database 123 may be updated by the server 125 and/or traffic control device 126. The mobile device 122, vehicle 124, and traffic control device 126 may communicate with the geographic database through the network 127. In some cases, the geographic database may be stored in, connected to, or otherwise in communication with the cloud. The geographic database 123 may be referred to as a cloud-connected geographic database.

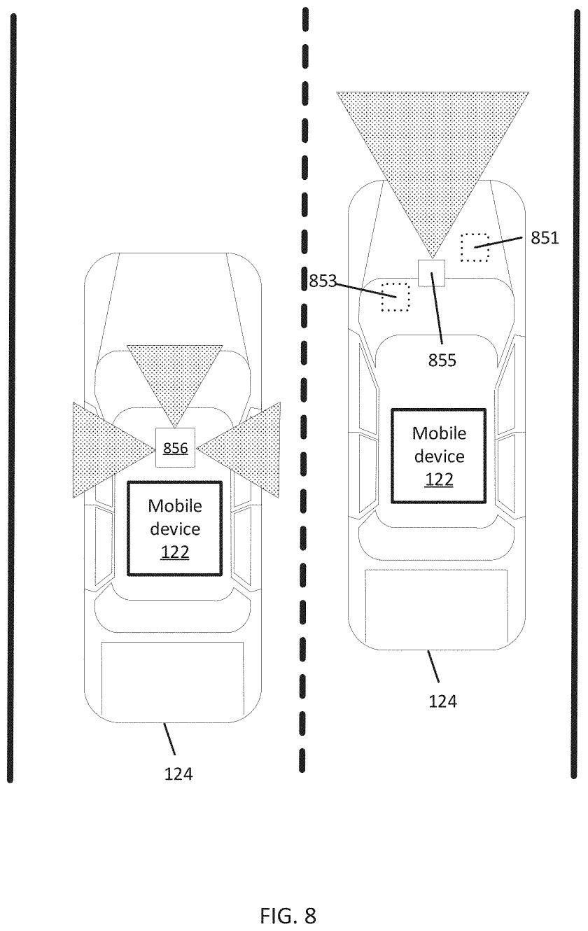

The vehicle 124 may have one or more sensors for determining position, orientation, speed, and other telemetric information. In some cases, the vehicle 124 may be in communication with or include a mobile device 122. References throughout to a vehicle 124 may indicate a vehicle 124 including a mobile device 122. The vehicle 124 is described in greater detail below with respect to FIG. 8.

The server 125 may be configured to facilitate transfers of navigation information, navigation commands, and historical traffic data between the traffic control device 126 and the geographic database 123. The server 125 may be configured to process navigation information and/or navigation commands to update historical traffic data.

The traffic control device 126 may be a “virtual” traffic control device. In one example, the traffic control device 126 may be a node (e.g. an edge node) in a MEAC network. While communication between the mobile devices 122, the traffic control device 126, and the server 125 may be facilitated through the network 127, the mobile devices 122 and the traffic control device 126 may communicate device-to-device (e.g. through one or more links between nodes, mobile devices, traffic control devices, and/or vehicles in the MEAC network). In this way, because the transmission, reception, and processing of data occurs at the edges (e.g. nodes) of the MEAC network (as opposed to transfers to and processing in the cloud), data may be transferred and processed with low latency between the mobile devices 122 and the traffic control device 126.

The traffic control device 126 may be configured to regulate traffic on a path or path segment. For example, the traffic control device 126 may regulate the flow of traffic at an intersection between two paths. While physical traffic lights rely on a presence at the intersection and an unobstructed view by human operators to control traffic, the traffic control device may be present virtually, as part of a network (e.g. as a node in the network), without requiring a physical presence at the intersection. Instead of relying on a physical presence, the traffic control device 126 controls traffic by receiving data from mobile devices 122 (e.g. standalone or as integrated into vehicles 124) and sending navigation commands to the devices. The navigation command may be an autonomous driving command instructing the mobile device 122 or the vehicle 124 to take an action.

As opposed to the traffic control device, a physical traffic light may instruct an approaching vehicle to stop by displaying a red light signal at an intersection. The desired result (the approaching car stopping) is achieved by a human operator seeing the red light signal and responding by stopping the car. The human error present in traffic control by physical traffic lights may be diminished because the traffic light control device 126 sends a navigation command (e.g. directly or through one or more nodes) instructing the approaching vehicle 124 to stop, without relying on a visual signal sent to a human operator.

The network 127 may be a wired or wireless connection between the mobile devices 122, the traffic control device 126, the server 125, other computing devices, or a combination thereof. While the network 127 is illustrated as being connected to the mobile devices 122, the traffic control device 126, and the server 125, the network 127 may comprise each of the mobile devices 122, the traffic control device 126, and the server 125. In this way, the mobile devices 122, the traffic control device 126, and the server 125 may be referred to as nodes in an edge computing network, such as a MEAC network.

The mobile device 122, geographic database 123, vehicle 124, server 125, and traffic control device 126 may be connected to, a part of, or otherwise configured to communicate through a MEAC network.

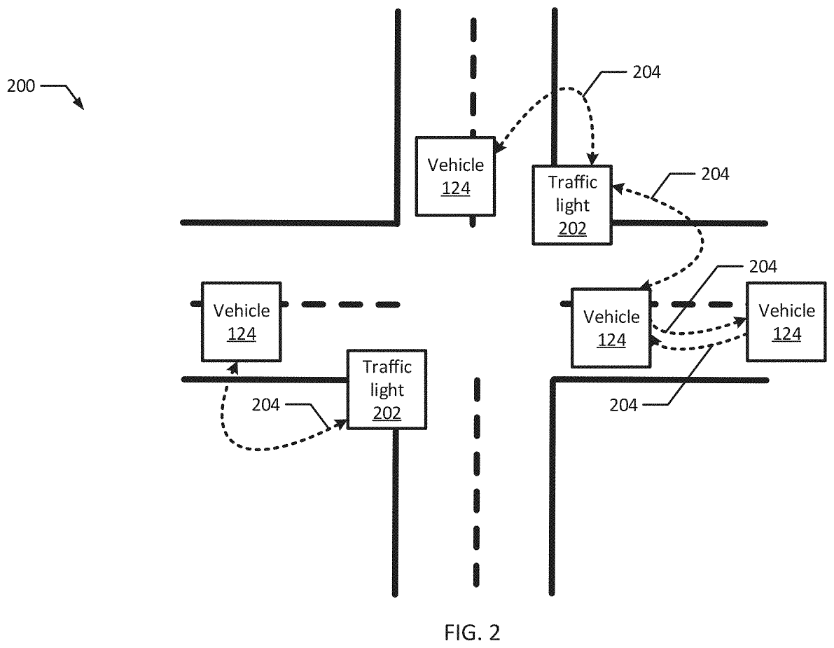

FIG. 2 illustrates a first embodiment 200 of vehicle communication including vehicles 124 and physical traffic lights 202 communicating via links 204 at an intersection of two paths. Four vehicles are present at an intersection, vehicle 1, vehicle 2, vehicle 3, and vehicle 4. Links 204 (e.g. wireless links over Wi-Fi, 5G cellular service, and/or other standards) allow for communication between a vehicle and the physical traffic lights 202 (e.g. the traffic lights and vehicle 1 and vehicle 4), and between two vehicles 124 (e.g. between vehicle 2 and vehicle 3).

The links 204 between the vehicles 124 and the traffic lights 202 rely on the physical presence of the traffic light 202 at the intersection. While communication over the links 204 may allow for adaptive timing of the traffic lights 202, traffic flow through the intersection is still regulated by the physical presence of the traffic lights 202 at the intersection and depends on a visual signal from the traffic lights 202. As a result, human error is introduced into the traffic flow, thereby reducing efficiency.

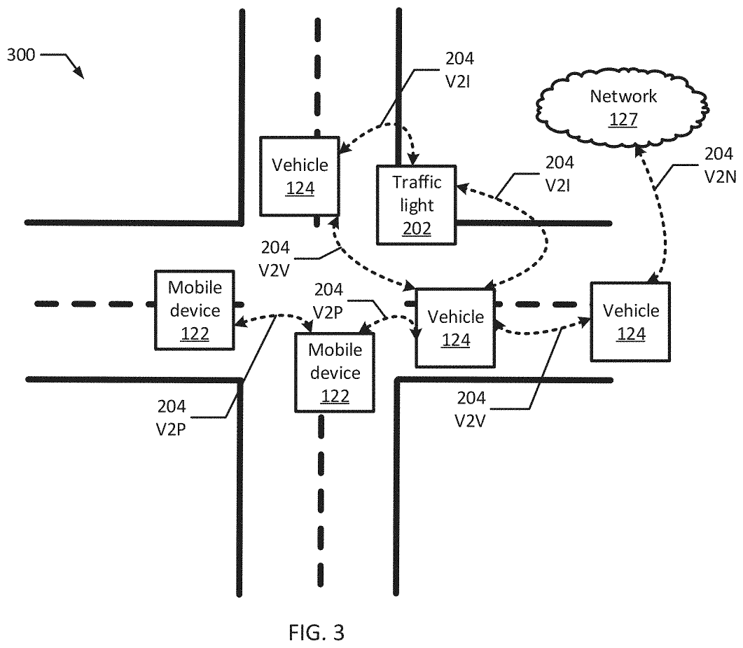

FIG. 3 illustrates a second embodiment 300 of vehicle communication including mobile devices 122, vehicles 124, and physical traffic lights 202 communicating via links 204 at an intersection of two paths. The links 204 facilitate communication between two vehicles 124 (vehicle to vehicle, V2V), between a mobile device 122 and a vehicle 124 (vehicle to person, V2P), between a vehicle 124 and the traffic light 202 (vehicle to infrastructure, V2I), and between vehicles 124 and the network 127 (vehicle to network, V2N). Altogether, the communication links 204 between the mobile devices 122, vehicles 124, traffic light 202, and network 207 may form a MEAC network.

Despite the presence of a MEAC network, traffic flow through the intersection is still regulated by the physical presence of the traffic light 202 at the intersection. In this way, the regulation of traffic flow relies on existing, traditional infrastructure present at the intersection, which may be prone to malfunction and failure. Regulation of traffic flow may be facilitated with information transferred via the links 204, but retains a significant point of failure by relying on physical presence of the traffic light 202 and other infrastructure physically present at the intersection.

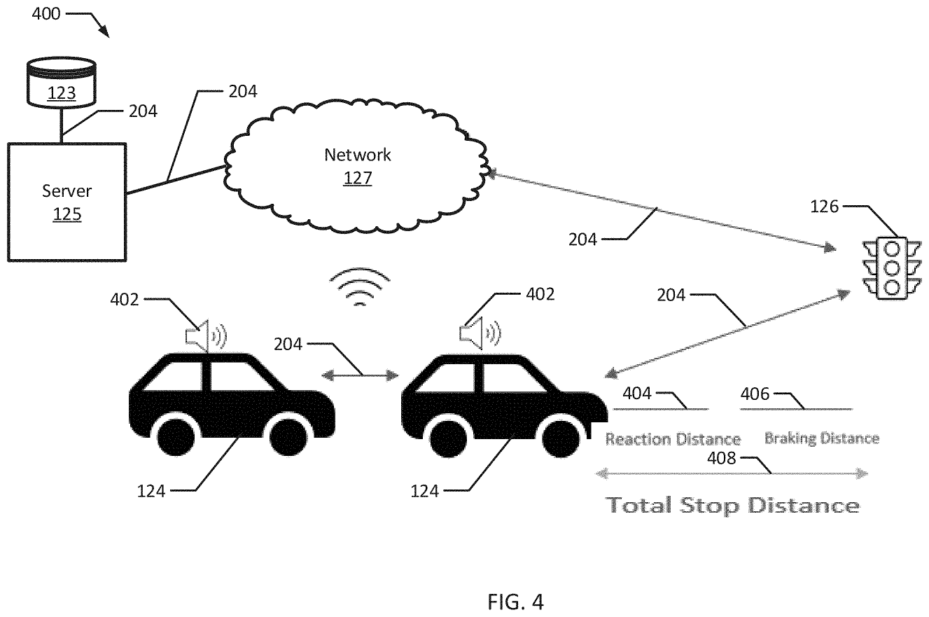

FIG. 4 illustrates a second embodiment of a traffic light system 400 including vehicles 124, a virtual (e.g. non-physical) traffic control device 126, and a network 127. The traffic control device 126 may be an edge node of the traffic light system, such as an edge node of a MEAC network. Communication links 204 facilitate communication between two vehicles 124, between a vehicle 124 and the traffic control device 126, and between the traffic control device 126 and a network 127. The vehicles 124 may include an audiovisual indicator 402.

Data, such as navigation data (or, navigation information), navigation commands, and/or historical traffic data may pass through one or more of the links 204. Each link over which data is transferred (or, each node through which the data passes, such as the server 125, nodes in the network 127 (e.g. routers and wireless communication points), the traffic control device 126, the vehicles 124, and the mobile devices 122) may be referred to as a “hop.” When, for example, data is transmitted between a vehicle 124 and the cloud (e.g. a cloud-connected geographic database 123), the data may pass over multiple hops, thereby degrading performance (e.g. latency). However, when data is sent, received, and/or processed between edge nodes in the MEAC network, the data may pass over a fewer number of hops. By processing the data (e.g. determining a navigation command) by an edge node of the MEAC network (such as a traffic control device 126), latency and other performance measures may be improved.

As a vehicle 124 approaches an intersection or autonomous vehicle control point, it may be desirable to have the vehicle 124 stop so that other traffic may flow through the intersection. The vehicle 124 may transmit navigation information to the traffic control device 126. The navigation information may include, for example, a geographic location of the vehicle 124, a path navigated by the vehicle 124, an acceleration distance, a deceleration distance, data regarding obstacles detected by sensors in communication with the vehicle 124, a reaction time, a reaction distance, a success of implementing a navigation command, and/or other information. Based on receiving the navigation information from the vehicle 124, the traffic control device 126 may, for example, determine a navigation command for the vehicle to stop.

In one example of a traffic control device 126 regulating traffic flow, a vehicle 124 (in some cases, without a human operator, but having one or more human passengers) is driving on a path with a 40 km/h speed limit. At an intersection between two roads, the vehicle 124 approaches the traffic control device 126 that is stopping traffic on the path (e.g. “has turned red”). An intersection without a physical traffic light and/or moderated by the traffic control device 126 may be referred to as an autonomous vehicle control point. The traffic control device 126 may receive navigation information from the vehicle 124 and/or the network 127 (such as from a geographic database 123 in communication with the network 127). In some cases, the geographic database 123 may include historical information (e.g. navigation information collected over time) regarding a geographic location or path segment associated with the traffic control device 126. The navigation information may include, for example, an acceleration ratio, an obstacle detected by sensors that are part of or in communication with the vehicle 124, a reaction distance 404 of the vehicle 124 (e.g. 9.5 m), a braking distance 406 of the vehicle 124 (e.g. 9.5 m), a path traversed by the vehicle 124, a speed, an angle of steering input, an occupancy, a weight, and other information. The traffic control device 126 may determine a total stopping distance 408 based on the navigation information. In the example, the total stopping distance 408 may be 19 m.

Based on the navigation information and/or additional processing (such as determination of the total stopping distance 408), the traffic control device 126 may determine and output a navigation command to the vehicle 124. The navigation command may be transmitted via the links 204. The navigation command may instruct the vehicle 124 to slow down or stop.

In some cases and in response to the navigation command, the vehicle 124 may present an alert through the audiovisual indicator 402 to advise the occupants that the vehicle 124 will act on the navigation command (e.g. will slow or stop). For example, the alert may be presented through speakers, a display, or a light panel of the audiovisual indicator 402. To alert the passengers to the impending deceleration, a rapid beep or visual notification (e.g. through a light panel or display) may be transmitted through the speakers inside the AV. Additionally, the navigation command may be output by the vehicle 124 and/or the traffic control device 126 to other vehicles 124 in the vicinity of the vehicle 124 that received the navigation command and/or the traffic control device 126.

In some cases, the traffic control device 126 may determine the navigation command based on information applied to a machine learning framework (e.g. a machine learned model). The information applied to or input to the machine learning framework may include the navigation information sent by the vehicle 124 and received by the traffic control device 126, historic data of number of vehicles transiting an intersection, historic data of accidents reported at an intersection, and Reality Index data (e.g. speed of vehicles and traffic patterns). The Reality Index is a collection of linked location factors created from a constant stream of data from sensors, drones, connected cars, cameras, and chips. The Reality Index organizes data and users through place and time to create a digital representation of the physical world.

Further, by transferring the navigation information to the traffic control device 126 or other elements of a MEAC network, the performance and safety of the vehicle 124 may be monitored. For example, in the case on an accident, telemetric data contained in the navigation information (e.g. the speed, acceleration/deacceleration and exact moment of the impact) as well as other information (e.g. time fluctuations in the signal changes from the traffic control device 126) may help assess what failure or malfunction led to the accident and how to prevent such failures. In this way, the vehicle 124, traffic control device 126 and MEAC network act as a “black box.” As the navigation information may be added to the historical information, the traffic control device 126 may adapt over time to improve the safety and efficiency of the traffic flow. Further, the traffic control device 126 may help prevent proximity accidents.

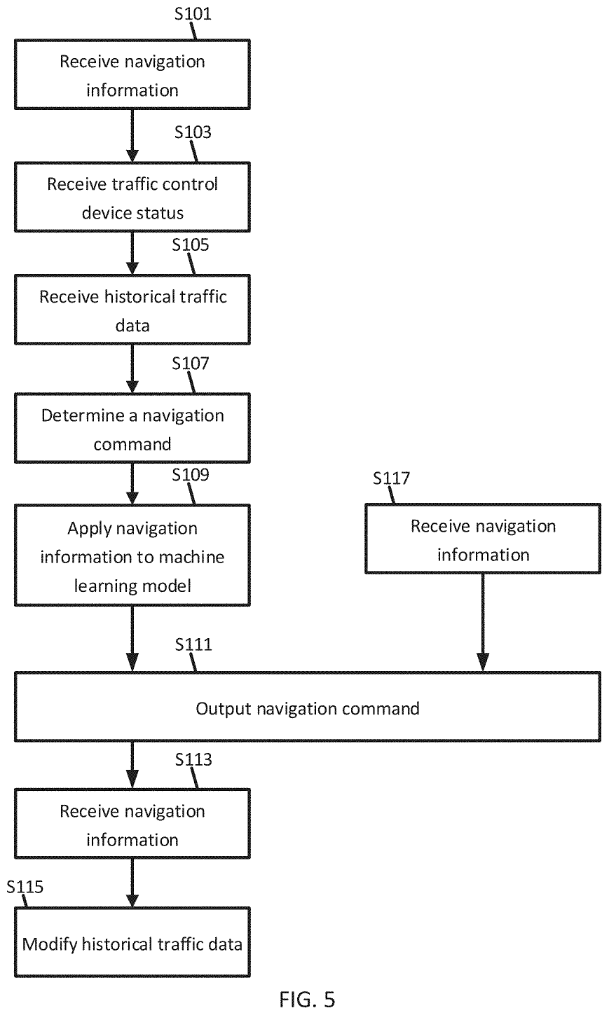

FIG. 5 illustrates an example flow chart for the systems of FIG. 1 and FIG. 4. Additional, different, or fewer acts may be included. For example, act S105, act S117, act S113, and/or act S115 may be omitted. The acts may be performed in a different order than shown. For example, act S101 may proceed from act S105. The acts may be performed by the traffic control device 126 of FIG. 1 and FIG. 4.

In act S101, navigation information is received. The vehicle 124 or a mobile device 122 (such as a mobile device 124 in communication with the vehicle 124) generates the navigation data. The navigation data may be sent from the vehicle 124 or mobile device 122 to the traffic control device 126 directly (e.g. through a wired or wireless connection) or through one or more intermediaries, such as another vehicle 124, another mobile device 122, or another element of a MEAC network. The navigation information may be received via a number of hops less than a number of hops over which the historical traffic data (e.g. as described with respect to act 111) is received from the geographic database 123.

In act S103, a status of a traffic control device 126 is received. The status may be a status of the traffic control device 126 performing the method, or from another traffic control device 126. For example, the status may be received from a memory of the traffic control device 126. The status indicates a traffic flow decision of the traffic control device 126. For example, the status may indicate that traffic in one path segment or one lane may pass, may stop, or may proceed with caution. In another example, the status indicates a speed limit, a minimum distance between vehicles, a lane closure, or other information about traffic flow on the path.

In act S105, historical traffic data is received. In some cases, the historical traffic data may be stored in the geographic database 123 (e.g. a cloud-connected geographic database) and served to the traffic control device 126 over the network 127. The historical traffic data may be received via a number of hops greater than a number of hops over which the navigation information is received from the vehicle. In some other cases, the historical traffic data (or a portion of it) may be stored locally to the traffic control device 126, such as in memory. The historical traffic data may include a geographic location of vehicles 124 around an autonomous vehicle control point associated with the traffic control device 126, a path navigated by the vehicles 124, an acceleration distance, a deceleration distance, data regarding obstacles detected by sensors in communication with the vehicle 124, a reaction time, a reaction distance, and/or a success of implementing a navigation command. The historical traffic data may inform the navigation command determined for a vehicle 124. For example, previous navigation commands executed successfully by vehicles 124 may form a basis for the navigation command determined by the traffic control device 126.

In act S107, a navigation command is determined. The navigation command may be determined based on the navigation information, the status, and/or the historical traffic data. The navigation command may instruct the autonomous vehicle 124 to perform a particular maneuver, such as slowing down, stopping, turning, accelerating, or pulling off a roadway. In some cases, the navigation command may instruct the vehicle 124 to form a platoon with one or more other vehicles 124 in the vicinity. For example, when the navigation command includes a platooning instruction, the navigation command may also be output to other vehicles 124 entering the platoon, either by the traffic control device 126 or by the vehicle 124.

In act S109, the navigation information and the status are applied to a machine learning framework. The machine learning framework may include a machine learned model that has been trained on historical traffic data. The machine learned model may be trained to accept navigation information and a status of the traffic control device 126 and to output a navigation command. In this way, the navigation command may be determined based on the navigation information and the status of the traffic control device 126 applied to the machine learned model. In some cases, when the machine learned model is available to the traffic control device, the historical data may not be received by the traffic control device. Because the machine learned model embodies the historical traffic data, reception of the historical traffic data by the traffic control device 126 may be unnecessary.

In act S111, the navigation command is output to the vehicle 124. The navigation command may be relayed to the vehicle via one or more links 204. For example, the navigation command may be received by the vehicle 124 by passing through links connecting the vehicle 124, other vehicles 124, one or more mobile devices 124, the traffic control device 126, the network 127, and other elements of the MEAC network.

In some cases, the navigation command may be sent to one or more other vehicles 124. For example, navigation information received from other vehicles may be used to determine whether to send the navigation command to other vehicles as well.

The navigation command may be sent through one or more links of the network (e.g. between edge nodes of a MEAC network), such as through a vehicle-to-vehicle link of the MEAC network, through a vehicle-to-node link of the MEAC network, through a vehicle-to-mobile device link of the MEAC network, or a combination thereof.

In act S113, more navigation information is received from the vehicle 124. The vehicle may transmit more navigation information so that the traffic control device 126 may receive information regarding the outcome of sending the navigation command to the vehicle 124. This further navigation information may include a geographic location of the vehicle 124, a path navigated by the vehicle 124, an acceleration distance, a deceleration distance, data regarding obstacles detected by sensors in communication with the vehicle 124, a reaction time, a reaction distance, and/or a success of implementing a navigation command.

In act S115, the historical traffic data is modified based on the navigation information. The navigation information (including the navigation information sent before and/or after the traffic control device 126 determined the navigation command) may be collected and used to update the historical traffic data. In this way, the traffic control device 126 may, over time, improve the efficiency and safety of traffic flowing through the autonomous vehicle control point. In some cases, the machine learned model may be re-trained or updated based on the updated or modified historical traffic data. As more and more navigation information is added to the historical data, a more optimal navigation command for each vehicle 124 or mobile device 122 may be determined.

In act S117, navigation information is received from a second vehicle. Additional vehicles 124 may be notified of the navigation command sent to the vehicle 124 so that the other vehicles may react ahead of time to the vehicle 124 implementing the navigation command.

To determine whether to send the navigation command to another vehicle 124, the traffic control device may receive navigation information from other vehicles 124. As above, the navigation information may include a geographic location of the vehicle 124, a path navigated by the vehicle 124, an acceleration distance, a deceleration distance, data regarding obstacles detected by sensors in communication with the vehicle 124, a reaction time, a reaction distance, and/or a success of implementing a navigation command.

The navigation information from the other vehicle 124 may be compared to one or more criteria. For example, the geographic location of the other vehicle 124 may be compared to a location of the first vehicle 124 or the autonomous vehicle control point. If the other vehicle is within a predetermined range of either, the navigation command may be sent to the other vehicle. In another example, the navigation information may include an identity of a platoon to which the other vehicle belongs. The navigation command may be sent to one or all members in a platoon. If another vehicle in the platoon has received the navigation command, or if the first vehicle 124 in not in the platoon of the other vehicle 124, the navigation command may, in some cases, not be sent to the other vehicle 124. Other criteria may be considered to determine whether to send the navigation command to additional vehicles.

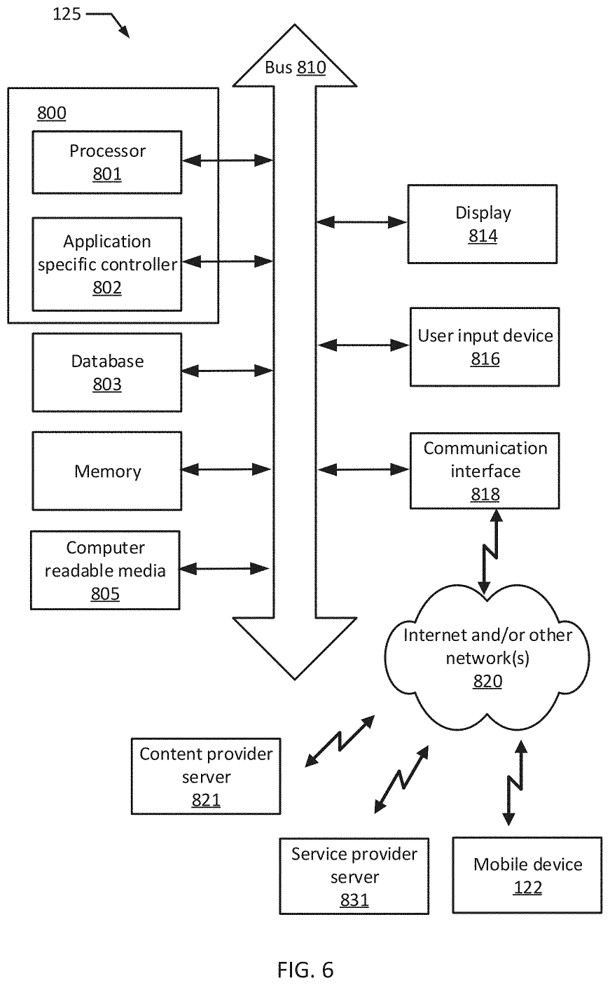

FIG. 6 illustrates an example server 125 for the system of FIG. 1. The server 125 may include a bus 810 that facilitates communication between a controller that may be implemented by a processor 801 and/or an application specific controller 802, which may be referred to individually or collectively as controller 800, and one or more other components including a database 803, a memory 804, a computer readable medium 805, a display 814, a user input device 816, and a communication interface 818 connected to the internet and/or other networks 820. The contents of database 803 are described with respect to database 123. The server-side database 803 may be a master database that provides data in portions to the database 703 of the traffic control device 126. Additional, different, or fewer components may be included.

The memory 804 and/or the computer readable medium 805 may include a set of instructions that can be executed to cause the server 125 to perform any one or more of the methods or computer-based functions disclosed herein. In a networked deployment, the system of FIG. 6 may alternatively operate or as a client user computer in a client-server user network environment, or as a peer computer system in a peer-to-peer (or distributed) network environment. It can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. While a single computer system is illustrated, the term “system” shall also be taken to include any collection of systems or sub-systems that individually or jointly execute a set, or multiple sets, of instructions to perform one or more computer functions.

The server 125 may be in communication through the network 820 with a content provider server 821 and/or a service provider server 831. The server 125 may provide the point cloud to the content provider server 821 and/or the service provider server 831. The content provider may include device manufacturers that provide location-based services associated with different locations POIs that users may access.

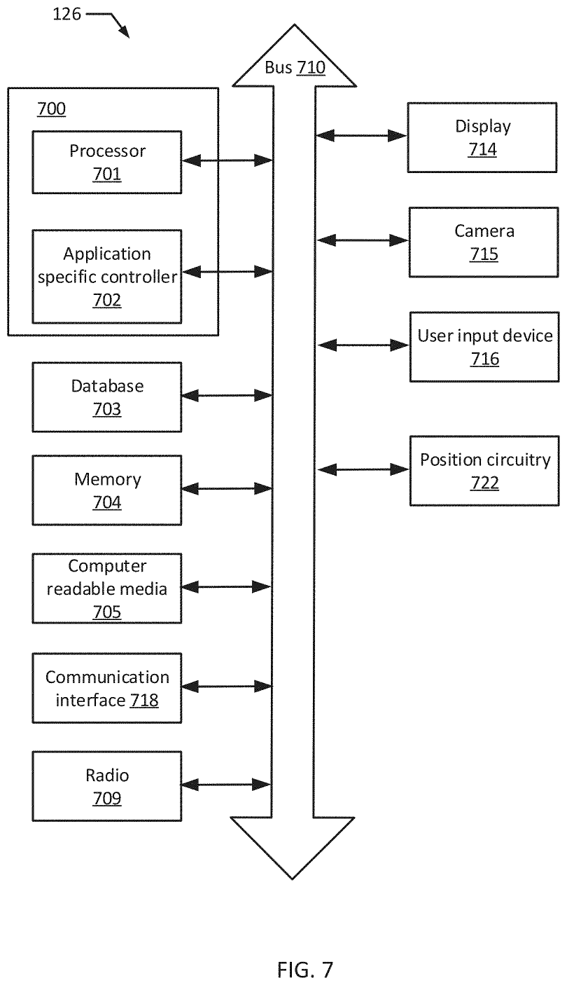

FIG. 7 illustrates an example traffic control device for the systems of FIG. 1 and FIG. 4. The traffic control device 126 may include a bus 710 that facilitates communication between a controller that may be implemented by a processor 701 and/or an application specific controller 702, which may be referred to individually or collectively as controller 700, and one or more other components including a database 703, a memory 704, a computer readable medium 705, a communication interface 718, a radio 709, a display 714, a camera 715, a user input device 716, and position circuitry 722. The contents of the database 703 are described with respect to database 123. The device-side database 703 may be a user database that receives data in portions from the database 703 of the traffic control device 126. The communication interface 718 connected to the internet and/or other networks (e.g., network 820 shown in FIG. 6). Additional, different, or fewer components may be included.

FIG. 8 illustrates an exemplary vehicle 124 associated with the systems of FIG. 1 and FIG. 4. The vehicles 124 may include a variety of devices that collect position data as well as other related sensor data for the surroundings of the vehicle 124. The position data may be generated by a global positioning system, a dead reckoning-type system, cellular location system, or combinations of these or other systems, which may be referred to as position circuitry or a position detector. The positioning circuitry may include suitable sensing devices that measure the traveling distance, speed, direction, and so on, of the vehicle 124. The positioning system may also include a receiver and correlation chip to obtain a GPS or GNSS signal. Alternatively or additionally, the one or more detectors or sensors may include an accelerometer built or embedded into or within the interior of the vehicle 124. The vehicle 124 may include one or more distance data detection device or sensor, such as a LIDAR device. The distance data detection sensor may generate point cloud data. The distance data detection sensor may include a laser range finder that rotates a mirror directing a laser to the surroundings or vicinity of the collection vehicle on a roadway or another collection device on any type of pathway. The distance data detection device may generate the trajectory data. Other types of pathways may be substituted for the roadway in any embodiment described herein.

A connected vehicle includes a communication device and an environment sensor array for reporting the surroundings of the vehicle 124 to the server 125 and/or traffic control device 126. The connected vehicle may include an integrated communication device coupled with an in-dash navigation system. The connected vehicle may include an ad-hoc communication device such as a mobile device 122 or smartphone in communication with a vehicle system. The communication device connects the vehicle to a network including at least one other vehicle and at least one server. The network may be the Internet or connected to the Internet.

The sensor array may include one or more sensors configured to detect surroundings of the vehicle 124. The sensor array may include multiple sensors. Example sensors include an optical distance system such as LIDAR 856, an image capture system 855 such as a camera, a sound distance system such as sound navigation and ranging (SONAR), a radio distancing system such as radio detection and ranging (RADAR) or another sensor. The camera may be a visible spectrum camera, an infrared camera, an ultraviolet camera, or another camera.

In some alternatives, additional sensors may be included in the vehicle 124. An engine sensor 851 may include a throttle sensor that measures a position of a throttle of the engine or a position of an accelerator pedal, a brake senor that measures a position of a braking mechanism or a brake pedal, or a speed sensor that measures a speed of the engine or a speed of the vehicle wheels. Another additional example, vehicle sensor 853, may include a steering wheel angle sensor, a speedometer sensor, or a tachometer sensor.

A mobile device 122 may be integrated in the vehicle 124, which may include assisted driving vehicles such as autonomous vehicles, highly assisted driving (HAD), and advanced driving assistance systems (ADAS). Any of these assisted driving systems may be incorporated into mobile device 122. Alternatively, an assisted driving device may be included in the vehicle 124. The assisted driving device may include memory, a processor, and systems to communicate with the mobile device 122. The assisted driving vehicles may respond to routes including path segments) received from geographic database 123 and the server 125 and driving commands or navigation commands received from the traffic control device 126.

The term autonomous vehicle may refer to a self-driving or driverless mode in which no passengers are required to be on board to operate the vehicle. An autonomous vehicle may be referred to as a robot vehicle or an automated vehicle. The autonomous vehicle may include passengers, but no driver is necessary. These autonomous vehicles may park themselves or move cargo between locations without a human operator. Autonomous vehicles may include multiple modes and transition between the modes. The autonomous vehicle may steer, brake, or accelerate the vehicle based on the position of the vehicle in order, and may respond to routes including path segments received from geographic database 123 and the server 125 and driving commands or navigation commands received from the traffic control device 126.

A highly assisted driving (HAD) vehicle may refer to a vehicle that does not completely replace the human operator. Instead, in a highly assisted driving mode, the vehicle may perform some driving functions and the human operator may perform some driving functions. Vehicles may also be driven in a manual mode in which the human operator exercises a degree of control over the movement of the vehicle. The vehicles may also include a completely driverless mode. Other levels of automation are possible. The HAD vehicle may control the vehicle through steering or braking in response to the on the position of the vehicle and may respond to routes including path segments received from geographic database 123 and the server 125 and driving commands or navigation commands received from the traffic control device 126.

Similarly, ADAS vehicles include one or more partially automated systems in which the vehicle alerts the driver. The features are designed to avoid collisions automatically. Features may include adaptive cruise control, automate braking, or steering adjustments to keep the driver in the correct lane. ADAS vehicles may issue warnings for the driver based on the position of the vehicle or based on the routes including path segments received from geographic database 123 and the server 125 and driving commands or navigation commands received from the traffic control device 12.

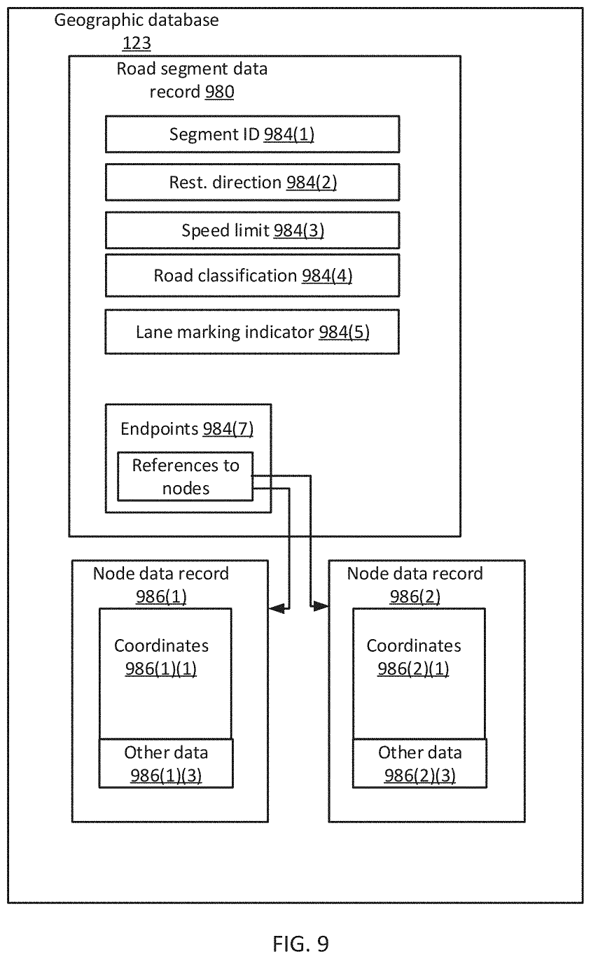

FIG. 9 illustrates an exemplary database 123 with components of a road segment data record 980 contained in the geographic database 123. The historical traffic data may include one or more road segment data records 980. The road segment data record 980 may include a segment ID 984(1) by which the data record can be identified in the geographic database 123. Each road segment data record 980 may have associated information (such as “attributes”, “fields”, etc.) that describes features of the represented road segment. The road segment data record 980 may include data 984(2) that indicate the restrictions, if any, on the direction of vehicular travel permitted on the represented road segment. The road segment data record 980 may include data 984(3) that indicate a speed limit or speed category (i.e., the maximum permitted vehicular speed of travel) on the represented road segment. The road segment data record 304 may also include classification data 984(4) indicating whether the represented road segment is part of a controlled access road (such as an expressway), a ramp to a controlled access road, a bridge, a tunnel, a toll road, a ferry, and so on. The road segment data record may include location fingerprint data, for example a set of sensor data for a particular location.

The geographic database 123 may include road segment data records 980 (or data entities) that describe current, historical, or future navigation commands and/or navigation information. Additional schema may be used to describe road objects. The attribute data may be stored in relation to geographic coordinates (e.g., the latitude and longitude) of the end points of the represented road segment. In one embodiment, the data 984(7) are references to the node data records 986 that represent the nodes corresponding to the end points of the represented road segment.

The road segment data record 980 may also include or be associated with other data that refer to various other attributes of the represented road segment. The various attributes associated with a road segment may be included in a single road segment record or may be included in more than one type of record which cross-references to each other. For example, the road segment data record may include data identifying what turn restrictions exist at each of the nodes which correspond to intersections at the ends of the road portion represented by the road segment, the name, or names by which the represented road segment is identified, the street address ranges along the represented road segment, and so on.

The road segment data record 908 may also include endpoints 984(7) that reference one or more node data records 986(1) and 986(2) that may be contained in the geographic database 123. Each of the node data records 986 may have associated information (such as “attributes”, “fields”, etc.) that allows identification of the road segment(s) that connect to it and/or its geographic position (e.g., its latitude and longitude coordinates). The node data records 986(1) and 986(2) include the latitude and longitude coordinates 986(1)(1) and 986(2)(1) for their node, the node data records 986(1) and 986(2) may also include other data 986(1)(3) and 986(2)(3) that refer to various other attributes of the nodes. In one example, the node data records 986(1) and 986(2) include the latitude and longitude coordinates 986(1)(1) and 986(2)(1) and the other data 986(1)(3) and 986(2)(3) reference other data associated with the node.

The geographic database 123 may include map data representing a road network or system including road segment data and node data. The road segment data represent roads, and the node data represent the ends or intersections of the roads. The road segment data and the node data indicate the location of the roads and intersections as well as various attributes of the roads and intersections. Other formats than road segments and nodes may be used for the map data. The map data may include structured cartographic data or pedestrian routes. The map data may include map features that describe the attributes of the roads and intersections. The map features may include geometric features, restrictions for traveling the roads or intersections, roadway features, or other characteristics of the map that affects how vehicles 124 or mobile device 122 travel through a geographic area. The geometric features may include curvature, slope, or other features. The curvature of a road segment describes a radius of a circle that in part would have the same path as the road segment. The slope of a road segment describes the difference between the starting elevation and ending elevation of the road segment. The slope of the road segment may be described as the rise over the run or as an angle. The geographic database 123 may also include other attributes of or about the roads such as, for example, geographic coordinates, street names, address ranges, speed limits, turn restrictions at intersections, and/or other navigation related attributes (e.g., one or more of the road segments is part of a highway or toll way, the location of stop signs and/or stoplights along the road segments), as well as points of interest (POIs), such as gasoline stations, hotels, restaurants, museums, stadiums, offices, automobile dealerships, auto repair shops, buildings, stores, parks, etc. The databases may also contain one or more node data record(s) which may be associated with attributes (e.g., about the intersections) such as, for example, geographic coordinates, street names, address ranges, speed limits, turn restrictions at intersections, and other navigation related attributes, as well as POIs such as, for example, gasoline stations, hotels, restaurants, museums, stadiums, offices, automobile dealerships, auto repair shops, buildings, stores, parks, etc. The geographic data may additionally or alternatively include other data records such as, for example, POI data records, topographical data records, cartographic data records, routing data, wireless network performance data, and maneuver data.

The geographic database 123 may contain at least one road segment database record 980 (also referred to as “entity” or “entry”) for each road segment in a particular geographic region. The geographic database 123 may also include a node database record (or “entity” or “entry”) for each node in a particular geographic region. The terms “nodes” and “segments” represent only one terminology for describing these physical geographic features, and other terminology for describing these features is intended to be encompassed within the scope of these concepts. The geographic database 123 may also include location fingerprint data for specific locations in a particular geographic region.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionalities as described herein.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP, HTTPS) represent examples of the state of the art. Such standards are periodically superseded by faster or more efficient equivalents having essentially the same functions. Accordingly, replacement standards and protocols having the same or similar functions as those disclosed herein are considered equivalents thereof.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

As used in this application, the term ‘circuitry’ or ‘circuit’ refers to all of the following: (a) hardware-only circuit implementations (such as implementations in only analog and/or digital circuitry) and (b) to combinations of circuits and software (and/or firmware), such as (as applicable): (i) to a combination of processor(s) or (ii) to portions of processor(s)/software (including digital signal processor(s)), software, and memory(ies) that work together to cause an apparatus, such as a mobile phone or server, to perform various functions) and (c) to circuits, such as a microprocessor(s) or a portion of a microprocessor(s), that require software or firmware for operation, even if the software or firmware is not physically present.

This definition of ‘circuitry’ applies to all uses of this term in this application, including in any claims. As a further example, as used in this application, the term “circuitry” would also cover an implementation of merely a processor (or multiple processors) or portion of a processor and its (or their) accompanying software and/or firmware. The term “circuitry” would also cover, for example and if applicable to the particular claim element, a baseband integrated circuit or applications processor integrated circuit for a mobile phone or a similar integrated circuit in server, a cellular network device, or other network devices.

Processors suitable for the execution of a computer program include, by way of example, both general and special purpose microprocessors, and anyone or more processors of any kind of digital computer. Generally, a processor receives instructions and data from a read only memory or a random-access memory or both. The essential elements of a computer are a processor for performing instructions and one or more memory devices for storing instructions and data. Generally, a computer also includes, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry. In an embodiment, a vehicle may be considered a mobile device, or the mobile device may be integrated into a vehicle.

To provide for interaction with a user, embodiments of the subject matter described in this specification can be implemented on a device having a display, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is a tangible storage medium. Accordingly, the disclosure is considered to include any one or more of a computer-readable medium or a distribution medium and other equivalents and successor media, in which data or instructions may be stored. These examples may be collectively referred to as a non-transitory computer readable medium.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

The society of automotive engineers (SAE) sorts driver assistance features into different levels, ranging from 0 to 5.

Level 0: An automated system may issue warnings and may momentarily intervene, but has no sustained vehicle control.

Level 1: The driver and the automated system share control of the vehicle. Examples of level 1 include adaptive cruise control (ACC), where the driver controls steering and the automated system controls speed, and parking assistance, where steering is automated while speed is manual. Level 1 may be referred to as “hands off” because the driver should be prepared to retake full control of the vehicle at any time. Lane keeping assistance (LKA) Type II is a further example of level 1 driver assistance.

Level 2: The automated system takes full control of the vehicle (accelerating, braking, and steering). The driver must monitor the driving and be prepared to intervene immediately at any time if the automated system fails to respond properly. Though level 2 driver assistance may be referred to as “hands off” because the automated system has full control of acceleration braking and steering, in some cases, contact between hand and steering wheel is often required to confirm that the driver is ready to intervene. In this way, the driver supervises the actions of the driver assistance features.

Level 3: The driver can safely turn their attention away from the driving tasks, e.g. the driver can text or watch a movie. Level 3 may be referred to as “eyes off.” The vehicle may handle situations that call for an immediate response, such as emergency braking. The driver should still be prepared to intervene within some limited period of time, often specified by the manufacturer, when called upon by the vehicle to do so. The car has a so-called “traffic jam pilot” that, when activated by a human driver, allows the car to take full control of all aspects of driving in slow-moving traffic at up to 60 kilometers per hour (37 miles per hour). However, the function works only on highways with a physical barrier separating one stream of traffic from oncoming traffic.

Level 4: Similar automated control as in level 3, but no driver attention is required for safety. For example, the driver may safely go to sleep or leave the driver's seat. Level 4 may be referred to as “mind off” or “driverless.” Self-driving in level 4 may be supported only in limited spatial areas (e.g. within geofenced areas) or under special circumstances, like traffic jams. Outside of these areas or circumstances, the vehicle may safely abort the trip (e.g. park the car) if the driver does not retake control.

Level 5: No human intervention is required to drive the vehicle. As a result, a vehicle with level 5 driver assistance features may not require or have a steering wheel installed. An example would be a robotic taxi. Level 5 driver assistance may be referred to as “autonomous driving” because the vehicle may drive on a road without human intervention. In many cases, it is used as the same term as a driverless car, or a robotic car.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings and described herein in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments.

One or more embodiments of the disclosure may be referred to herein, individually, and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, are apparent to those of skill in the art upon reviewing the description.

The Abstract of the Disclosure is provided to comply with 37 C.F.R. § 1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

It is intended that the foregoing detailed description be regarded as illustrative rather than limiting and that it is understood that the following claims including all equivalents are intended to define the scope of the invention. The claims should not be read as limited to the described order or elements unless stated to that effect. Therefore, all embodiments that come within the scope and spirit of the following claims and equivalents thereto are claimed as the invention.

We claim:

1. A method of directing traffic flow, the method comprising:
receiving, by a processor, navigation information from a vehicle in a multi-edge communication network;
receiving, by the processor, a status of an edge node traffic control device of the multi-edge communication network, wherein the edge node traffic control device is configured to regulate traffic flow on a path segment;
determining, by the processor, a navigation command based on the navigation information and the status; and
outputting, by the processor, the navigation command to the vehicle through the multi-edge communication network.

2. The method of claim 1, further comprising:
receiving, by the processor, second navigation information from a second vehicle in the multi-edge communication network; and
outputting, by the processor, the navigation command to the second vehicle based on the second navigation information through a vehicle-to-vehicle link of the multi-edge communication network, through a vehicle-to-node link of the multi-edge communication network, through a vehicle-to-mobile device link of the multi-edge communication network, or a combination thereof.

3. The method of claim 1, further comprising:
applying, by the processor, the navigation information and the status to a machine learned model,
wherein the navigation command is determined based on the navigation information and the status applied to the machine learned model.

4. The method of claim 1, further comprising:
receiving, by the processor, historical traffic data stored in a cloud-connected geographic database,
wherein the navigation command is determined based on the historical traffic data.

5. The method of claim 4, wherein receiving the historical traffic data occurs via a number of hops greater than a number of hops over which the navigation information is received from the vehicle.

6. The method of claim 4, further comprising:
receiving, by the processor, second navigation information from the vehicle based on the vehicle implementing the navigation command; and
modifying, by the processor, the historical traffic data to include the navigation information, the second navigation information, or the navigation information and the second navigation information.

7. The method of claim 6, wherein the navigation information, the second navigation information, or the navigation information and the second navigation information comprise a geographic location of the vehicle, a path navigated by the vehicle, an acceleration distance, a deceleration distance, data regarding obstacles detected by sensors in communication with the vehicle, a reaction time, a reaction distance, a success of implementing a navigation command, or a combination thereof.

8. The method of claim 1, wherein the edge node traffic control device is associated with a geographic location of the path segment.

9. The method of claim 8, wherein the navigation command is determined based on the navigation information indicating an approach of the vehicle to the geographic location.

10. A traffic control system comprising:
a multi-edge network comprising:
a memory; and
a processor in communication with the memory and configured to execute instructions stored in the memory operable to:
receive navigation data from a vehicle in communication with the multi-edge network;
receive a status of an edge node traffic control device of the traffic control system and in communication with the multi-edge network, wherein the edge node traffic control device is configured to regulate traffic flow on a path segment;
determine a navigation command based on the navigation data and the status; and
output the navigation command to the vehicle through the multi-edge network.

11. The system of claim 10, wherein the memory stores instructions further operable to:
receive second navigation data from a second vehicle; and
output the navigation command to the second vehicle based on the second navigation data through a vehicle-to-vehicle link of the multi-edge network, through a vehicle-to-node link of the multi-edge network, through a vehicle-to-mobile device link of the multi-edge network, or a combination thereof.

12. The system of claim 10, wherein the memory stores instructions further operable to:
apply the navigation data and the status to a machine learned model,
wherein the navigation command is determined based on the navigation data and the status applied to the machine learned model.

13. The system of claim 10, wherein the memory stores instructions further operable to:
receive historical traffic data from a geographic database stored in a cloud-connected geographic database through a network-to-node link of,
wherein the navigation command is determined based on historical traffic data.

14. The system of claim 13, wherein the memory stores instructions further operable to:
receive second navigation data from the vehicle after the vehicle has implemented the navigation command; and
update the historical traffic data based on the navigation data, the second navigation data, or the navigation data and the second navigation data.

15. The system of claim 14, wherein the navigation data, the second navigation data, or the navigation data and the second navigation data comprise a path navigated by the vehicle, an acceleration distance, a deceleration distance, data regarding obstacles detected by sensors in communication with the vehicle, a reaction time, a reaction distance, a success of implementing a navigation command, or a combination thereof.

16. The system of claim 10, wherein the network node is associated with a geographic location of the path segment.

17. The system of claim 16, wherein the navigation command is determined based on the navigation data indicating an approach of the vehicle to the geographic location.

18. A non-transitory computer-readable medium including instructions that when executed are operable to:
receive navigation data from a vehicle via a vehicle-to-node link of a communication network;
receive a status of an edge node traffic control device in communication with the communication network, wherein the edge node traffic control device is configured to regulate traffic flow on a path segment;
determine a navigation command based on the navigation data and the status; and
output the navigation command to the vehicle through the vehicle-to-node link of the communication network.

19. The non-transitory computer-readable medium of claim 18, wherein the edge node traffic control device is a network node associated with a geographic location of the path segment, and
wherein the geographic location of the at least one path segment comprises an autonomous vehicle control point.

20. The non-transitory computer-readable medium of claim 18, including instructions that when executed are operable to:
receive second navigation data from a second vehicle through the vehicle-to-vehicle link, through a vehicle-to-node link of the communication network, through a vehicle-to-mobile device link of the communication network, or a combination thereof; and
output the navigation command to the second vehicle based on the second navigation data and through the communication network.
